(19) United States
(12) Patent Application Publication
(10) Pub. No.: US 2010/0146634 A1
(43) Pub. Date: Jun. 10, 2010

(54) DATA PROTECTION DEVICE AND METHOD

(75) Inventors: Su Gil CHOI, Daejeon (KR); Sung Ik JUN, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunication Research Institute, Daejeon (JP)

(21) Appl. No.: 12/566,280

(22) Filed: Sep. 24, 2009

(30) Foreign Application Priority Data
Dec. 8, 2008 (KR) 10-2008-0124200

(51) Int. Cl. G06F 21/00

(52) U.S. Cl. 726/26

(57) ABSTRACT

Provided is a data protecting device and method. When a specific application requests an access to sealed data, an operating system generates application identity information without interruption by the corresponding application, and writes the generated application identity information in a platform configuration register that can be reset in a trusted platform module. Upon having received the unsealing request, the trusted platform module transmits data to the application when the unsealing condition included in the sealed data block corresponds to the state value of the currently operated platform written in a platform configuration register in the trusted platform module.

### CROSS-REFERENCE TO RELATED APPLICATION

This application claims priority to and the benefit of Korean Patent Application No. 10-2008-0124200 filed in the Korean Intellectual Property Office on Dec. 8, 2008, the entire contents of which are incorporated herein by reference.

### BACKGROUND OF THE INVENTION

(a) Field of the Invention

The present invention relates to a data protecting device and method, and particularly, it relates to a data protecting device and method for controlling an application for accessing data sealed by a trusted platform module.

(b) Description of the Related Art

The data unsealing method defined by the trusted computing group (TCG) decodes sealed data on a trusted platform module (TPM), and uses the data only when the unsealing condition relating to the sealed data matches the current platform state. Here, the unsealing condition represents values that are expected when the platform can be trusted, and it can be written in the platform configuration register (PCR). The unsealing condition is encoded with the data, and the TPM is allowed to use data only when the unsealing condition satisfies the values that are stored in the PCR of the TPM during the unsealing process.

With the conventional data unsealing method, it is difficult to express the condition for determining whether the platform is trusted with the PCR values, and it also has a problem that any user can access the unsealed data if they know the unsealing password. Further, information on the entire applications performed on the platform is written in the PCR according to the PCR extending method defined by the TCG, which has the drawback in that it is difficult to determine which application is performed with the value written in the PCR after many applications are performed. In addition, since the value that is written in the PCR according to the performance order even if the applications that can be trusted are performed, it is difficult to express the state of the platform that can be trusted with the value written in the PCR. Therefore, since it is difficult to determine the reliability of the platform in the case of following the conventional method, there is a low probability of using the sealing method and the unsealing method so as to actually protect the data.

Also, even if the operating system on the platform and the entire applications can be trusted, there can be a case of controlling the application that is requested to seal the data to access the unsealed data. For example, in the digital rights management (DRM) system, a DRM client program has a function of securely using and managing a key for decoding the encoded contents, and if the key is unsealed to be used while the DRM client program is not operated, the key may be leaked. However, it is difficult to check what the unsealing-requested application is in the TPM when following the conventional method.

Also, another data unsealing method for writing a value for representing the trusted state of the application in the virtual PCR, writing the virtual PCR value in the PCR in the TPM when a TPM instruction requiring the value written in the PCR is performed, and executing the TPM instruction has been proposed. The method writes the application's trusted state in the PCR, and it can determine whether to trust the application by using the information, but it cannot be used for determining whether a program has requested an instruction from the TPM since it cannot identify without fail which application it is. The method also does not propose a method for guaranteeing that an acquired trusted state is always correct when acquiring the application's trusted state information. Further, the method may problematically write a value that is different from the trusted state of the application since the method only specifies that it can write the virtual PCR value in the PCR in the TPM and it proposes no method for controlling writing it in the PCR in the TPM.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a data protecting device and method for reducing the data leak danger by controlling applications accessible to the data sealed by the TPM.

An exemplary embodiment of the present invention provides a data protecting device including: a trusted platform module including a plurality of platform configuration registers, receiving an unsealing request, and outputting unsealed data when an unsealing condition acquired by decoding a sealed data block corresponds to at least one among current platform state values written in the platform configuration registers; a trusted platform module interface for storing identity information of a first application in a platform configuration register that can be reset from among the platform configuration registers, transmitting the unsealing request provided by the first application to the trusted platform module, and transmitting the unsealed data to the first application; and an application identifier for generating identity information of the first application and transmitting the same to the trusted platform module interface.

Another embodiment of the present invention provides a data protecting device including: a trusted platform module for, when receiving a unsealing request, outputting unsealed data when an unsealing condition acquired by decoding a sealed data block, identity information of the application currently operated as a process, and a current platform state value stored in an inner platform configuration register; an application identifier for generating and outputting identity information of the application; and a trusted platform module interface for, when receiving the unsealing request from the application, acquiring identity information of the application from the application identifier, transmitting it with the unsealing request to the trusted platform module, and transmitting the unsealed data to the application.

Another embodiment of the present invention provides a method for protecting data sealed by a trusted platform module, including: when an unsealing request of a first application is transmitted to a trusted platform module device driver supported by an operating system, generating identity information of the first application through constituent elements supported by the operating system; writing identity information of the first application in a first platform configuration register that can be reset in the trusted platform module through the trusted platform module device driver; acquiring a data and unsealing condition by decoding a data block sealed through the trusted platform module; comparing the unsealing condition and at least one among current platform state value stored in a plurality of platform configuration registers including the first platform configuration register in the trusted platform module; and transmitting the data to the first application when at least one among current platform state values corresponds to the unsealing condition.

A method for protecting data of a trusted platform module includes: when the first application transmits an unsealing request to an operating system, receiving the unsealing request and identity information of the first application generated by the operating system from the operating system; acquiring data and unsealing condition by decoding a sealed data block corresponding to the unsealing request; comparing identity information of the first application and a current platform state value stored in a platform configuration register in the trusted platform module to the unsealing condition; and transmitting the data to the first application when identity information of the first application and the current platform state value stored in the platform configuration register in the trusted platform module correspond to the unsealing condition.

### BRIEF DESCRIPTION OF THE DRAWINGS

FIG. 1 shows a conceptual view of data sealing and unsealing according to a first exemplary embodiment of the present invention.

FIG. 2 shows a configuration diagram of a data protecting device according to a first exemplary embodiment of the present invention.

FIG. 3 shows a flowchart of a data protecting method according to a first exemplary embodiment of the present invention.

FIG. 4 shows a configuration diagram of a data protecting device according to a second exemplary embodiment of the present invention.

FIG. 5 shows a flowchart of a data protecting method according to a second exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A data protecting device and method according to an exemplary embodiment of the present invention will now be described in detail with reference to accompanying drawings.

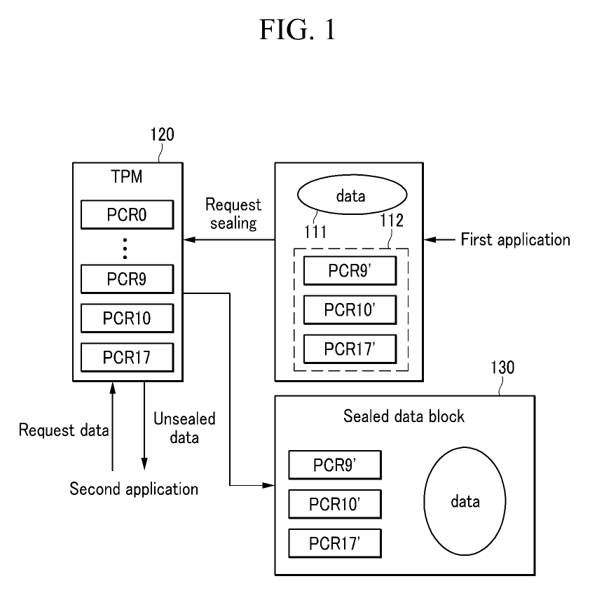

Referring to FIG. 1 to FIG. 3, a data protecting device and method according to a first exemplary embodiment of the present invention will be described.

FIG. 1 shows a conceptual view of data sealing and unsealing according to a first exemplary embodiment of the present invention.

Referring to FIG. 1, the first application prepares data 111 to be sealed, generates an unsealing condition 112 corresponding to the state value of the trusted platform that has to be satisfied so as to unseal the corresponding data, and expressed the generated unsealing condition 112 as a PCR value

For example, the first application can set PCR9′ as a hash value for a binary image of a trusted boot loader, PCR10′ as a hash value for a binary image of a trusted operating system, and PCR17′ for indicating application identity information. Here, identity information of an application accessible to the data 111 to be sealed, for example, identity information of a first application, is written in the application identity information.

Also, the first application transmits the unsealing condition 112 expressed in the PCR and the data 111 to the TPM 120 to request sealing, and the TPM 120 having received them encodes the data 111 and the unsealing condition 112 to generate a sealed data block 130. Data included in the sealed data block 130 will be referred to as ‘sealed data.’

When the second application uses the data in the sealed data block 130, the second application requests corresponding data from the TPM 120. In this instance, the second application can be the first application or another application.

When the second application requests the data in the sealed data block 130, the TPM 120 decodes the sealed data block 130 to acquire the data and the unsealing condition. The TPM 120 compares the unsealing condition and the state value of the current platform written in the PCR in the TPM 120, determines whether the currently operated platform is trusted, that is, whether it matches the unsealing condition, and determines whether to transmit the unsealed data to the second application according to the determination result.

For example, when it is assumed that the unsealing condition established by the first application is written in PCR9′, PCR10′, and PCR17′, and the values corresponding to the unsealing condition, that is, the hash value of the binary image of the boot loader having loaded the operating system of the current platform, the hash value of the binary image of the currently operated operating system, and the identity information of the second application having requested the data are respectively written in the PCR9, PCR10, and PCR17 in the TPM 120, when the values written in the PCR9′, PCR10′, and PCR17′ match the values written in the PCR9, PCR10, and PCR17 in the TPM 120, the TPM 120 determines that the currently operated platform can be trusted. Here, as described for the PCR9 and the PCR10, the method for configuring the chain of trust defined by the TCG is used to write the hash value. The method for writing identity information of the second application having requested data from the PCR17 will be described later.

As described, the method for determining whether to allow access of the application to the sealed data can control the application to access the data by knowing a decoding key and a password for unsealing the sealed data. That is, the danger in which the data are illegally leaked or maliciously used can be reduced since it is possible to provided the data while the trusted boot loader loads the trusted system to operate it and the data-requested application has the usage right on the corresponding data.

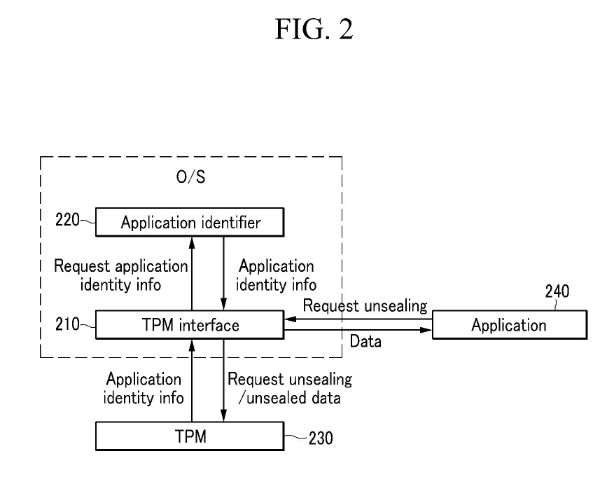

FIG. 2 shows a configuration diagram of a data protecting device according to a first exemplary embodiment of the present invention.

Referring to FIG. 2, the data protecting device includes a TPM interface 210, an application identifier 220, and a TPM 230, and the application identifier 220 and the TPM interface 210 are provided by the operating system.

The TPM interface 210 performs the function of the TPM device driver, and performs an operation corresponding to the instruction provided by the application 240 that is operable as a current process. For example, when receiving a data sealing request including data and unsealing condition from the application 240, or receiving a data unsealing request, the TPM interface 210 transmits it to the TPM 230.

Here, when the instruction received from the application 240 needs identity information of the application 240 in a like manner of the data unsealing request, the TPM interface 210 requests identity information of the application 240 operated as a current process from the application identifier 220. Accordingly, when acquiring application identity information from the application identifier 220, the TPM interface 210 writes it in the PCR that can be reset in the TPM 230. For example, when the PCR that can be reset from among the PLR's in the TPM 230 is the PCR17, the TPM interface 210 writes application identity information in the PCR17. After writing the application identity information, the TPM interface 210 transmits the instruction provided by the application 240 (e.g., an unsealing request) to the TPM 230.

Here, the right of writing a specific value in the PCR that can be reset in the TPM. If the application can call the instruction for writing a specific value in the PCR that can be reset, it is because identity information of another application can be unsealed after it is written. Therefore, it is possible in the exemplary embodiment of the present invention for the TPM interface 210 performing the TPM device driver function supported by the operating system to write a specific value in the PCR that can be reset in the TPM 230.

It is assumed in the exemplary embodiment of the present invention that the TPM interface 210 knows in advance the instruction requiring identity information of the application in a like manner of the unsealing request.

The application identifier 220 generates identity information of the corresponding application when the TPM interface 210 requests identity information of the application corresponding to the current process. Here, the application's identity information must not be changed each time it is generated to be a process so as to perform the application, and it must not be changed while it is operated as the process. This is because the unsealing condition sealed with data includes application identity information, and it cannot be used as an unsealing condition if it is impossible to predict application identity information written in the PCR of the TPM 230 in the case of unsealing.

The process includes a text area including an execution code in a memory, a data area for storing data, and a stack area for storing a local variable. Here, the contents of the data area and the stack area cannot be used as identity information since they can be changed when the process is performed. However, the execution code of the text area is not changed while the process is performed, and the reproducing process from the application file to the memory is not changed. That is, the contents are not changed during the process in which the application is generated to be a process, and they are not changed while the process is operated. Therefore, it is possible to use the data of the text area of the current process as identity information of the application. Also, since the kernel code in which the process is performed by calling the device driver is on the same context as the process, the text area location of the process can be detected, and since the process receives no inputs from the application so as to check the text area location, it can be disguised as an application. Therefore, the application identifier 220 generates the hash value for the data in the text area existing in the memory as application identity information. That is, it generates the hash value for the execution code of the application as the application's identity information.

When the process for hashing the text area of the process memory is performed many times in order to generate application identity information in a like manner of the above-described exemplary embodiments, performance may be deteriorated. Therefore, while the process of the application is operated, the application identity information is generated once at first to store a process ID and the generated application identity information, and when application identity information for the corresponding process is needed, it can be used. In this case, the method for generating application identity information by hashing the text area may deteriorate performance a little less, and when the code of the text area is changed by an attack using a weak point of the application, the hash result is changed, and hence, application identity information is changed and unsealing fails, thereby making the data safer.

It is described in the exemplary embodiment of the present invention that the hash value for the execution code of the application is used for the application's identity information, and other types of information can be used as the application's identity information in the present invention.

Upon receiving a data sealing request including data and unsealing condition from the TPM interface 210, the TPM 230 encodes the data and the unsealing condition to generate a sealed data block as shown in FIG. 1.

Also, when receiving an unsealing request from the TPM interface 210, the TPM 230 decodes the corresponding data and unsealing condition. The TPM 230 determines whether the state value of the current platform written in the PCR in the TPM 230 corresponds to the decoded unsealing condition, and it transmits the decoded data to the application 240 through the TPM interface 210 when they correspond with each other. Here, application identity information written in the PCR that can be reset in the TPM 230 is compared to identity information of the application having the data access right from among the unsealing condition.

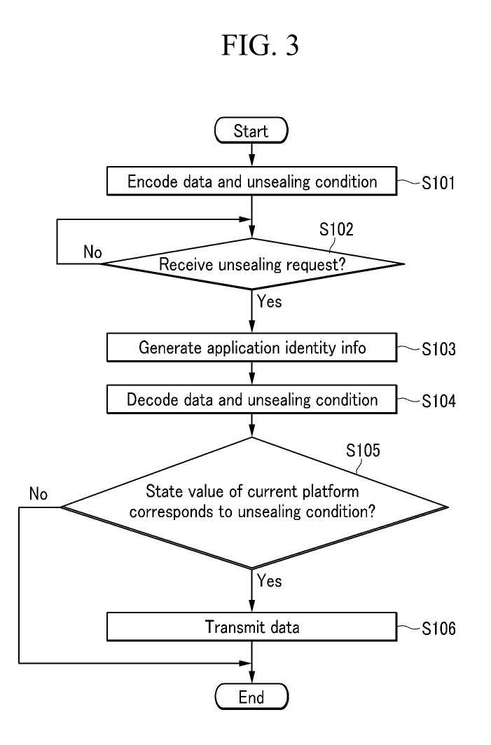

FIG. 3 shows a flowchart of a data protecting method according to a first exemplary embodiment of the present invention.

Referring to FIG. 3, when receiving a data sealing request including data and unsealing condition from the application 240 through the TPM interface 210, the TPM 230 encodes the corresponding data and unsealing condition to generate a sealed data block (S101).

When receiving an unsealing request from the application 240 corresponding to the current process (S102), the TPM interface 210 requests identity information of the application 240 from the application identifier 220. Accordingly, the application identifier 220 generates identity information of the application 240 (S103) and transmits it to the TPM interface 210. The TPM interface 210 having received it writes it in the PCR that can be reset in the TPM 230, and transmits the unsealing request to the TPM 230.

On having received it, the TPM 230 decodes the sealed data corresponding to the unsealing request to acquire the data and unsealing condition (S104), checks whether the decoded unsealing condition corresponds to the value that is written in the PCR in the TPM 230, that is, the state value of the currently operated platform including application identity information (S105), and transmits the decoded data, that is, the unsealed data, to the application 240 through the TPM interface 210 (S106).

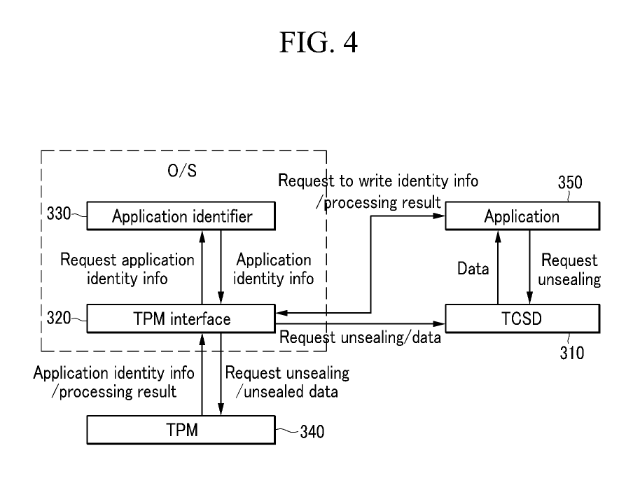

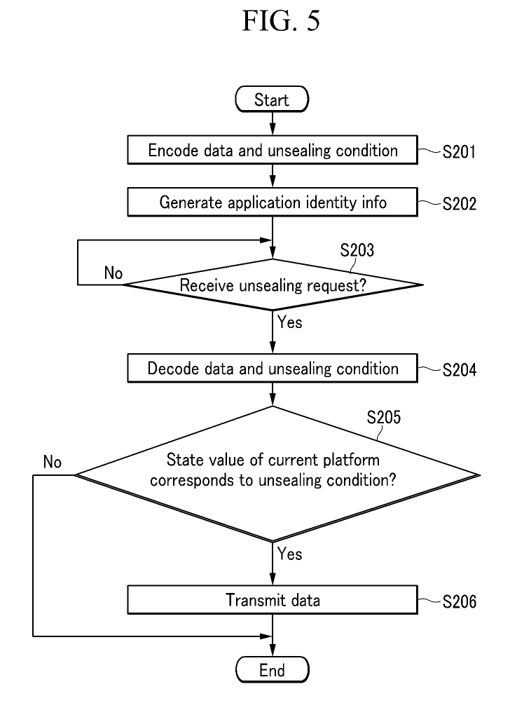

Referring to FIG. 4 and FIG. 5, a data protecting device and method according to a second exemplary embodiment of the present invention will now be described.

In the second exemplary embodiment of the present invention, the case in which the application does not directly call the TPM interface, that is, the TPM device driver, will be described as different from the first exemplary embodiment. When the platform uses the TCG software stack (TSS) defined by the TCG and the TSS core service (TCS) is operated as an individual process, the TCS calls the TPM device driver, and the identity information of the application cannot be generated by using the same method as the first exemplary embodiment.

FIG. 4 shows a configuration diagram of a data protecting device according to a second exemplary embodiment of the present invention, illustrating a data protecting device when the TCS is operable as a separable process.

Referring to FIG. 4, the data protecting device includes a TCS demon (TCSD) 310, a TPM interface 320, an application identifier 330, and a TPM 340, and the TPM interface 320 and the application identifier 330 are provided by the operating system.

The TCSD 310 performs the TCS function, that is, the software stack core service function defined by the TCG function, and it is operated as an individual process. Upon receiving the instruction from the application 350 by using a TSS service provider (TSP) library, the TCSD 310 transmits it to the TPM 340 through the TPM interface 320. That is, when receiving a data sealing request including data and unsealing condition or a data unsealing request from the application 350, the TCSD 310 transmits it to the TPM interface 320, receives unsealed data from the TPM interface 320, and transmits them to the application 350.

When the application 350 transmits the instruction through the TCSD 310, the operating system recognizes that the TCSD 310 has requested to process the instruction, and hence, the method for generating application identity information in a like manner of the first exemplary embodiment cannot be used. This is because the application identifier 330 detects the currently operated process as the TCSD 310 to generate identity information of the TCSD 310 other than identity information of the application 350 as application identity information. Therefore, in the second exemplary embodiment of the present invention, the application 350 directly requests the TPM interface 320 to generate the application identity information without using the TCSD 310 before requesting unsealing.

The TPM interface 320 performs the TPM device driver function, and performs an operation corresponding to the instruction provided by the TCSD 310. That is, the TPM interface 320 transmits the data sealing request or the data unsealing request provided by the TCSD 310 to the TPM 340, and transmits the writing process result of application identity information provided by the TPM 340 or unsealed data to the TCSD 310.

Further, when being requested to generate application identity information by the application 350, the TPM interface 320 requests identity information of the corresponding application 350 from the application identifier 330, and writes the application identity information transmitted by the application identifier 330 in the PCR that can be reset in the TPM 340. In the second exemplary embodiment of the present invention, the application 350 directly calls the TPM interface 320 when requesting the TPM interface 320 to generate identity information, and the present invention can request the TPM interface 320 to generate identity information of the application by using various method such as a system call or a proc file.

Upon receiving an identity information request of the application from the TPM interface 210, the application identifier 330 generates the corresponding application's identity information and transmits it to the TPM interface 210. In this instance, the method for the application identifier 330 to generate application identity information corresponds to the first exemplary embodiment, and no detailed description thereof will be provided.

When receiving the data sealing request including data and unsealing condition from the TPM interface 320, the TPM 340 encodes the data and unsealing condition to generate a sealed data block. Also, when the TPM interface 320 writes application identity information in the PCR that can be reset, the TPM 340 transmits the writing process result to the TPM interface 320. When receiving the unsealing request from the TPM interface 320, the TPM 340 decodes the corresponding data and unsealing condition, and when the state value of the current platform that is written in the PCR in the TPM 340 corresponds to the decoded unsealing condition, the TPM 340 transmits the decoded data to the TPM interface 320.

When generating application identity information in a like manner of the second exemplary embodiment of the present invention, the TPM 340 writes identity information generated by the direct request by the application 350 in the PCR, and controls the application 350 having requested to write the application identity information to use application identity information written in the corresponding PCR. If not, the TPM 340 recognizes the unsealing request transmitted by another application as that transmitted by the application 350 corresponding to application identity information written in the PCR, and then transmits unsealed data. Therefore, in the second exemplary embodiment of the present invention, the method transmits the password when returning the processing result after writing the application identity information in the PCR. In this case, the application 350 transmits the password when requesting unsealing so that the PCR in which application identity information of the application 350 is written may be used. For this, when the application identity information generated by the direct request by the application 350 is written in the PCR and the corresponding application 350 requests unsealing, the process for generating application identity information of the corresponding application 350 and writing it in the PCR is not performed and the unsealing request is transmitted to the TPM 340.

FIG. 5 shows a flowchart of a data protecting method according to a second exemplary embodiment of the present invention.

Referring to FIG. 5, when receiving a data sealing request including data and unsealing condition from the application 350, the TCSD 310 transmits them to the TPM 340 through the TPM interface 320. Therefore, the TPM 340 encodes the data and unsealing condition transmitted from the TPM interface 320 to to generate a sealed data block (S201).

When the application 350 directly requests to generate application identity information, the application identifier 330 generates identity information of the corresponding application 350 (S202), and receives application identity information from the application identifier 330 to write it in the PCR that can be reset in the TPM 340. Accordingly, the TPM 340 returns the writing processing result of application identity information, and the TPM interface 320 transmits the processing result to the application 350. Here, the processing result can include a password for using the PCR in which the corresponding application identity information is written.

When receiving the unsealing request of the application 350 through the TCSD 310 (S203), the TPM interface 320 transmits it to the TPM 340, and the TPM 230 having received it decodes the sealed data block corresponding to the unsealing request to acquire the data and unsealing condition (S204), checks whether the decoded unsealing condition corresponds to the value written in the PCR in the TPM 340, that is, the state value of the currently operated platform including application identity information (S505). When they correspond to each other, the TPM 230 transmits the decoded data, that is, the unsealed data to the TPM interface 320, and the TPM interface 320 transmits it to the application 350 through the TCSD 310 (S306). Here, when the processing result that is returned after the application identity information is written in the PCR includes a password, the application 350 transmits the password when requesting unsealing. Accordingly, the TPM 340 compares the unsealing condition and the value written in the PCR when the received password corresponds to the password corresponding to the PCR in which the application identity information is written.

When the application identity information is generated and is then written in the PCR that can be reset in the TPM in a like manner of the above-described exemplary embodiments, the application identity information written in the PCR may be changed. For example, when the unsealing request is receive and application identity information is written in the PCR in the TPM and a context switch occurs in a like manner of the first exemplary embodiment, application identity information written in the PCR can be changed. That is, when the current process is changed into another application, the changed application generates an unsealing request, and identity information of the changed application is overwritten in the same PCR before the data are unsealed by the context switch, identity information of the changed application can be used for the data unsealing process. Also, in a like manner of the second exemplary embodiment, when another application requests to write identity information before the application directly requests to write the application identity information, writes identity information of the corresponding application in the PCR in the TPM, and requests to unseal the data, the application identity information written in the PCR is changed.

One method for preventing the application identity information written in the PCR from being changed is to allocate different PCR's so as to write identity information for each application when there is no limit to the number of PCR's that can be reset in the TPM. However, the method has a limit because the number of PCR's that can be reset in the TPM is limited.

Another method is to generate application identity information, include it in the unsealing request, and transmit them to the TPM instead of writing it in the PCR in the TPM. The second method improves performance by reducing the number of communication times between the operating system and the TPM, and prevents the problem that the application identity information written in the PCR is changed into another value.

The other method is to use the method of writing application identity information in the PCR and the method of including application identity information in the unsealing request and transmitting them. In the case of using the third method, the TPM checks whether the unsealing request includes application identity information, and differently performs the unsealing instruction processing routine according to the checking result.

As described above, the exemplary embodiments of the present invention reduces the data leakage by controlling the application that is accessible to the data sealed by the TPM and controlling the application relating to the corresponding data to use the data. Further, in the process for checking identity information of the unsealing-requested application, interruption of application is prevented to increase the reliability of the checked application identity information, and the target for writing identity information of the application in the PCR is controlled to trust the identity information written in the PCR.

According to the present invention, data leakage danger is reduced by allowing the application relating to the sealed data to use the data.

In addition, reliability on application identity information is improved by preventing the application from interfering with generation of application identity information used for unsealing, and controlling the subject for writing identity information of the generated application in the PCR.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A data protecting device comprising:
a trusted platform module including a plurality of platform configuration registers, receiving an unsealing request, and outputting unsealed data when an unsealing condition acquired by decoding a sealed data block corresponds to at least one among current platform state values written in the platform configuration registers;
a trusted platform module interface for storing identity information of a first application in a platform configuration register that can be reset from among the platform configuration registers, transmitting the unsealing request provided by the first application to the trusted platform module, and transmitting the unsealed data to the first application; and
an application identifier for generating the identity information of the first application and transmitting the same to the trusted platform module interface.

2. The data protecting device of claim 1, wherein
the trusted platform module interface requests identity information of the first application from the application identifier when the first application requests generation of identity information of the first application without undergoing an additional process before transmitting the unsealing request.

3. The data protecting device of claim 2, wherein,
when acquiring the first application identity information from the application identifier, the trusted platform module interface writes identity information of the first application in the platform configuration register that can be reset, receives a processing result including a password from the trusted platform module, and transmits the processing result to the first application.

4. The data protecting device of claim 3, wherein
the unsealing request includes the password, and
the trusted platform module compares the unsealing condition and the current platform state value when the password corresponds to the password corresponding to the platform configuration register that can be reset.

5. The data protecting device of claim 1, wherein
upon receiving the unsealing request from the first application, the trusted platform module interface requests identity information of the first application from the application identifier, and writes identity information of the first application provided by the application identifier in the platform configuration register that can be reset.

6. The data protecting device of claim 1, wherein
the unsealing condition includes a hash value for a binary image of a boot loader that can be trusted, a hash value of a binary image of an operating system, and identity information of an application having an access right to the sealed data, and
the current platform state value includes a hash value of a binary image of a boot loader having loaded an operating system of a current platform, a hash value of a binary image of a currently driven operating system, and identity information of the first application.

7. The data protecting device of claim 6, wherein
identity information of the first application is a hash value of an execution code of the first application.

8. A data protecting device comprising:
a trusted platform module for, when receiving a unsealing request, outputting unsealed data when an unsealing condition acquired by decoding a sealed data block, identity information of the application currently operated as a process, and a current platform state value stored in an inner platform configuration register;
an application identifier for generating and outputting identity information of the application; and
a trusted platform module interface for, when receiving the unsealing request from the application, acquiring identity information of the application from the application identifier, transmitting it with the unsealing request to the trusted platform module, and transmitting the unsealed data to the application.

9. The data protecting device of claim 8, wherein
identity information of the application is a hash value for data in a text area in a memory of the current process.

10. A method for protecting data sealed by a trusted platform module comprising:
when an unsealing request of a first application is transmitted to a trusted platform module device driver supported by an operating system, generating identity information of the first application through constituent elements supported by the operating system;
writing identity information of the first application in a first platform configuration register that can be reset in the trusted platform module through the trusted platform module device driver;
acquiring a data and unsealing condition by decoding a data block sealed through the trusted platform module;
comparing the unsealing condition and at least one among current platform state value stored in a plurality of platform configuration registers including the first platform configuration register in the trusted platform module; and
transmitting the data to the first application when at least one among the current platform state value corresponds to the unsealing condition.

11. The method of claim 10, wherein
the generating of identity information of the first application includes
generating a hash value of an execution code of the first application as identity information of the first application.

12. The method of claim 11, wherein
the generating of identity information of the first application further includes,
when generating identity information of the first application for the first time, storing an ID corresponding to a process of the first application and identity information of the first application, and
the stored identity information of the first application is read and used when the identity information of the first application is needed after the identity information of the first application is stored.

13. The method of claim 10, wherein
the comparing includes
a hash value of a binary image of a boot loader that can be trusted included in the unsealing condition, a hash value of a binary image of an operating system that can be trusted, identity information of an application having an access right to the sealed data, a hash value of a binary image of a boot loader having loaded an operating system of a current platform included in the current platform state value, a hash value of a binary image of a currently operated operating system, and identity information of the first application.

14. The method of claim 13, wherein
the hash value of a binary image of a boot loader having loaded an operating system of the current platform and the hash value of a binary image of a currently operated operating system are written in the platform configuration registers by using the method for configuring the chain of trust defined by the trusted computing group.

15. The method of claim 10, wherein
the transmitting includes
transmitting the data to the first application through the trusted platform module device driver.

16. A method for protecting data of a trusted platform module comprising:
when the first application transmits an unsealing request to an operating system, receiving the unsealing request and identity information of the first application generated by the operating system from the operating system;
acquiring data and unsealing condition by decoding a sealed data block corresponding to the unsealing request;
comparing identity information of the first application and a current platform state value stored in a platform configuration register in the trusted platform module to the unsealing condition; and
transmitting the data to the first application when identity information of the first application and the current platform state value stored in the platform configuration register in the trusted platform module correspond to the unsealing condition.

17. The method of claim 16, wherein
the current platform state value includes a hash value of a binary image of a boot loader having loaded an operating system of a current platform and a hash value of a binary image of a currently operated operating system.

18. The method of claim 16, wherein
identity information of the first application is a hash value of data in a text area in a memory of a process corresponding to the first application.
